(19) United States
(12) Patent Application Publication
(10) Pub. No.: US 2005/0130490 A1
(43) Pub. Date: Jun. 16, 2005

(54) High speed cable assembly including finger grips

(75) Inventor: Corey Rose, Louisville, KY (US)

Correspondence Address: Keating & Bennett LLP, Suite 312, 10400 Eaton Place, Fairfax, VA, 22030, US

(73) Assignee: SAMTEC, Inc., New Albany, IN (US)

(21) Appl. No.: 10/735,752

(22) Filed: Dec. 16, 2003

(51) Int. Cl. H01R 13/00

(52) U.S. Cl. 439/483

(57) ABSTRACT

A cable assembly which prevents damage caused by a camming effect, prevents unwanted separation of the housing enclosing the electrical connectors, and allows for reworking of the coaxial cable without destroying the housings enclosing the electrical connectors includes two housings connected by at least one cable. At least one of the two housings includes at least one pair of finger grips extending from the housing such that the connector can be easily removed from a printed circuit board. At least one of the housings further includes top and bottom housing portions. The top and bottom housing portions are removably connected to each other by at least one latch and at least one fastening member, such as a screw.

### BACKGROUND OF THE INVENTION

1. Field of the Invention

The present invention relates to cable assemblies, and more specifically, the present invention relates to high speed cable assemblies with housings having finger grips.

2. Description of the Related Art

It is well known to attach electronic components, such as electrical connectors, integrated circuit components, capacitors, resistors, etc., to printed circuit boards (PCBs) and to connect PCBs to one another with high speed cable assemblies.

Conventional high speed cable assemblies 21 include two termination enclosures 22 and 23 connected by coaxial cables 24, as shown in FIG. 9.

In conventional high speed cable assemblies 21, it is difficult to un-mate or remove the high speed cable assemblies from PCBs (not shown) to which they are attached. Because of the amount of force which must be applied to un-mate a high speed cable assembly 21 from a PCB, the cable assembly can be damaged by a “camming” effect between the termination enclosures 22 and 23 and the PCB. Typically, the pins of the electrical connector 25 are bent and/or the termination enclosure 22 or 23 is broken by the “camming” effect. It is also known in conventional high speed cable assembly design to have the termination enclosures 22 and 23 contain electrical connectors 25 and 26 of the high speed cable assembly 21. When un-mating a high speed cable assembly 21 from a PCB, it is possible to separate or break off the unsupported termination enclosure portions 28 and 30 of the termination enclosures 22 and 23 to expose the supported termination enclosure portions 27 and 29 of the termination enclosures 22 and 23 which are mounted on the PCB.

One known solution to prevent the camming effect from damaging the high speed cable assembly 21 is to expose the area around the PCB where the termination enclosure 22 or 23 mates with the PCB. By exposing this area on the PCB, it is possible to apply force directly in-line with the termination enclosure 22 or 23. However, this solution can damage exposed leads on the PCB, requires finger contact with the glass fibers of the PCB, and reduces the amount of usable space on the surface of the PCB.

One known solution to prevent the termination enclosures 22 and 23 from separating is to ultrasonically weld the supported termination enclosure portion 27 or 29 to the unsupported termination enclosure portion 28 or 30, respectively. However, this solution suffers from drawbacks in that it requires additional processing steps and requires the unsupported termination enclosure portion 28 or 30 to be broken off the supported termination enclosure portion 27 or 29 (or vice versa) if the coaxial cables 24 need reworking or repair.

### SUMMARY OF THE INVENTION

In order to overcome the above-described problems, preferred embodiments of the present invention provide a cable assembly which prevents damage caused by the camming effect, prevents unwanted separation of a housing enclosing an electrical connector, and allows for reworking or repair of the coaxial cable without damaging the housing enclosing the electrical connector, while minimizing the assembly steps and the area occupied on a PCB upon which the housing is mounted.

According to a preferred embodiment of the present invention, a cable assembly includes first and second housings and at least one cable connecting the first and second housings. At least one of the first and second housings is provided with at least one finger grip. The at least one finger grip projects out from a surface of the at least one of the first and second housings to allow for finger gripping of the at least one of the first and second housings during un-mating of the cable assembly from a PCB upon which it is mounted.

The at least one cable is preferably a coaxial cable. The at least one cable preferably includes a plurality of cables, which are preferably coaxial cables.

In another preferred embodiment, at least two finger grips are provided on opposite surfaces of the at least one of the first and second housings. The at least two finger grips preferably include an integral protrusion extending from the surface of the at least one of the first and second housings. The at least two finger grips are arranged to be spaced from an upper surface and a lower surface of the at least one of the first and second housings. This position of the at least two finger grips allows for an operator to reliably and firmly grip the housings and remove the cable assembly from the PCB upon which it is mounted, without experiencing any of the disadvantages of the conventional devices described above.

According to another preferred embodiment of the present invention, the cable assembly further includes at least one housing which has a first housing portion and a second housing portion that are removably connected. Preferably, the first and second housing portions are removably connected by at least one fastening member, for example, a screw.

The first housing portion preferably includes a latch, and the second housing portion preferably includes an engaging recess which is arranged such that the latch of the first housing portion is a zero insertion force latch that fits into the engaging recess. The latch preferably includes at least one beveled surface.

According to another preferred embodiment of the present invention, the cable assembly further includes a board and at least one electrical connector disposed on the board. The board connects the at least one cable and the at least one electrical connector. The board and the at least one electrical connector are disposed inside of one of the first and the second housings.

The at least one electrical connector is preferably a mezzanine board-to-board connector or other suitable connector.

The at least one cable preferably includes a first set of coaxial cables connected to one side of the board and a second set of coaxial cables connected to another side of the board.

Another preferred embodiment of the present invention preferably includes a first housing portion and a second housing portion each having at least one cylinder portion and at least one post disposed thereon. The board is held in place by the at least one cylinder portion and by the at least one post located on the first or second housing portion.

Other features, elements, characteristics and advantages of the present invention will become more apparent from the following detailed description of preferred embodiments thereof with reference to the attached drawings.

### BRIEF DESCRIPTION OF THE DRAWINGS

FIG. 1 is an exploded view of a preferred embodiment of the present invention;

FIG. 2 is a side plan view of a preferred embodiment of the present invention shown in FIG. 1;

FIG. 3 is isometric view of a preferred embodiment of the present invention;

FIG. 4 is a top plan view of a preferred embodiment of the present invention shown in FIG. 3;

FIG. 5 is a top plan view of the bottom housing portion according to a preferred embodiment of the present invention;

FIG. 6 is sectional view along line A-A in FIG. 5 of the bottom housing portion according to a preferred embodiment of the present invention;

FIG. 7 is a bottom plan view of the top housing portion according to a preferred embodiment of the present invention;

FIG. 8 is a sectional view along line B-B in FIG. 7 of the top housing portion according to a preferred embodiment of the present invention;

FIG. 9 is isometric view of a conventional high speed connector assembly.

### DETAILED DESCRIPTION OF PREFERRED EMBODIMENTS

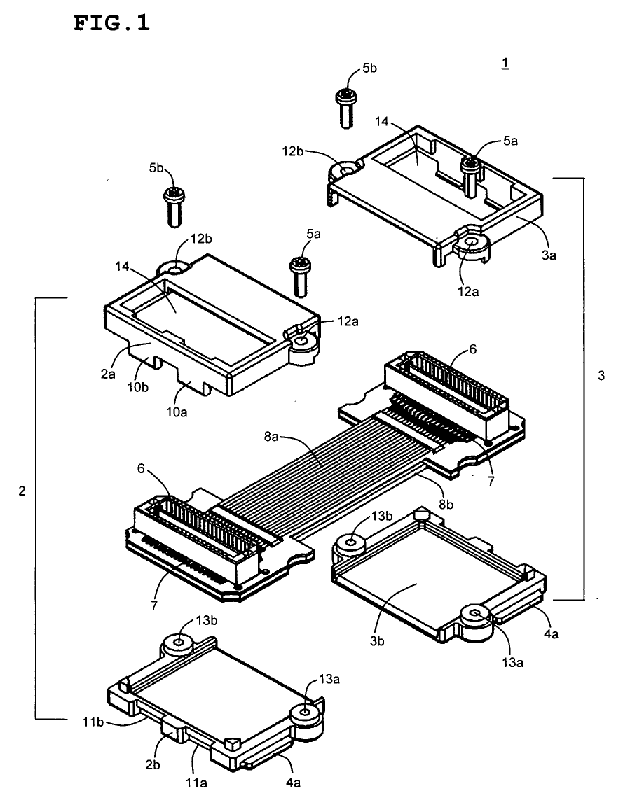

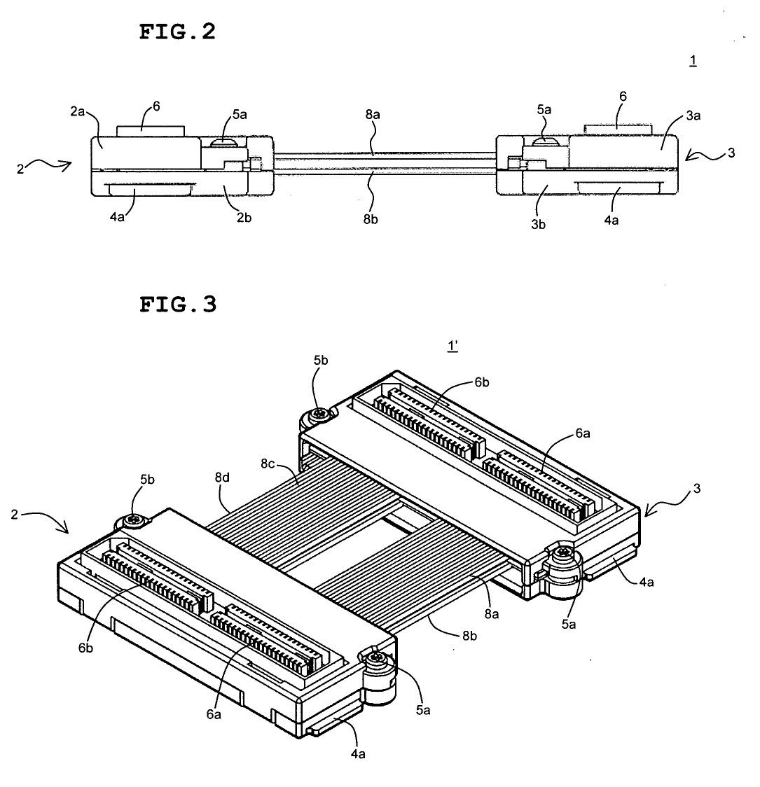

A high speed cable assembly 1 according to a preferred embodiment of the present invention is illustrated in FIGS. 1 and 2. The high speed cable assembly 1 preferably includes a first housing 2 and a second housing 3 connected by first coaxial cables 8a and second coaxial cables 8b.

The first housing 2 includes a top housing portion 2a and bottom housing portion 2b. The first housing 2 encloses a printed circuit board 7 which has electrical connector 6 connected to it. The electrical connector 6 may be a board-to-board mezzanine connector, edge card connector or other suitable electrical connector. The electrical connector 6 is mounted on the printed circuit board 7 using suitable known techniques.

The printed circuit board 7 preferably has top and bottom connecting pads (not shown) for connecting the first coaxial cables 8a and the second coaxial cables 8b to the top and bottom, respectively, of the printed circuit board 7. Preferably, the coaxial cables 8a and 8b are soldered to the PCB.

Other arrangements for connecting the printed circuit board 7 to the coaxial cables 8a, 8b could be used. For example, only the first coaxial cable 8a could be used to either connect to the top or the bottom of the circuit board 7. Another arrangement could include connecting both the first coaxial cable 8a and the second coaxial cable 8b to the either the top or the bottom the printed circuit board 7. Also, the printed circuit board 7 could be used to route the signals transmitted through the coaxial cables 8a and 8b across each other.

The top housing portion 2a includes latches 10a and 10b for insertion into engaging recesses 11a and 11b of the bottom housing portion 2b. The engaging recesses 11a and 11b are preferably constructed such that it requires zero insertion force for the latches 10a and 10b to be inserted into the engaging recesses 11a and 11b. It is also possible to use only one latch or to use three or more latches instead of the two latches 10a and 10b shown in the Drawings.

The top housing portion 2a further includes holes 12a and 12b and the bottom housing portion 2b further includes holes 13a and 13b. The first housing 2 is constructed by using fastening members 5a and 5b, such as screws, to secure the top housing portion 2a to the bottom housing portion 2b using holes 12a, 13a and 12b, 13b, respectively, such that the electrical connector 6 is exposed through the opening 14 of the top housing portion 2a. Further, the screws 5a and 5b engage holes 12a, 13a and 12b, 13b, respectively, such that the tops of screws 5a and 5b are below the plane defined by the top surface of the top housing portion 2a. It would also be possible to connect the top housing portion 2a with the bottom housing portion 2b using any other releasable fastening members or material such as metal or plastic clips or snap grooves.

The bottom housing portion 2b preferably includes finger grips 4a and 4b located on opposing sides of the bottom housing portion 2b. The finger grips 4a and 4b are preferably integral with the bottom housing portion 2b. For example, if the bottom housing portion 2b is formed of molded plastic, the finger grips 4a and 4b are integrally molded with the bottom housing portion 2b. The finger grips 4a and 4b are preferably located on the bottom housing portion 2b spaced a distance away from a bottom surface of the bottom housing portion 2b that is mounted on a printed circuit board (not shown) upon which the cable assembly 1 is mounted. This location allows an operator's fingers to securely engage the finger grips 4a and 4b from bottom and top surfaces of the finger grips 4a and 4b to allow for the operator to reliably engage and manipulate the finger grips 4a and 4b. It is also preferred that the finger grips 4a and 4b are located at a distance away from a top surface of the bottom housing portion 2b.

In addition, the finger grips 4a and 4b are preferably disposed on opposite side surfaces of the bottom housing portion 2b, and in-line with the location of the connector 6.

In an alternative arrangement, the finger grips 4a and 4b may be provided on the top housing portion 2a. In this case, the finger grips 4a and 4b are preferably located at a distance spaced away from the top surface and the bottom surface of the top housing portion 2a.

In addition, although a first finger grip 4a and a second finger grip 4b are shown in FIG. 1, for example, a single finger grip could be provided on any of the three side surfaces of either the top housing portion 2a or the bottom housing portion 2b where the cables 8a and 8b are not attached. In addition, more than two finger grips may be provided on any of the three side surfaces of either the top housing portion 2a or the bottom housing portion 2b.

The second housing 3 is preferably constructed in a similar manner as the first housing 2 where the reference numbers used to indicate the features of the first housing 2 are used to reference similar features in the second housing 3. The second housing 3 is preferably constructed by using fastening members such as screws 5a and 5b to secure the top housing portion 3a to the bottom housing portion 3b.

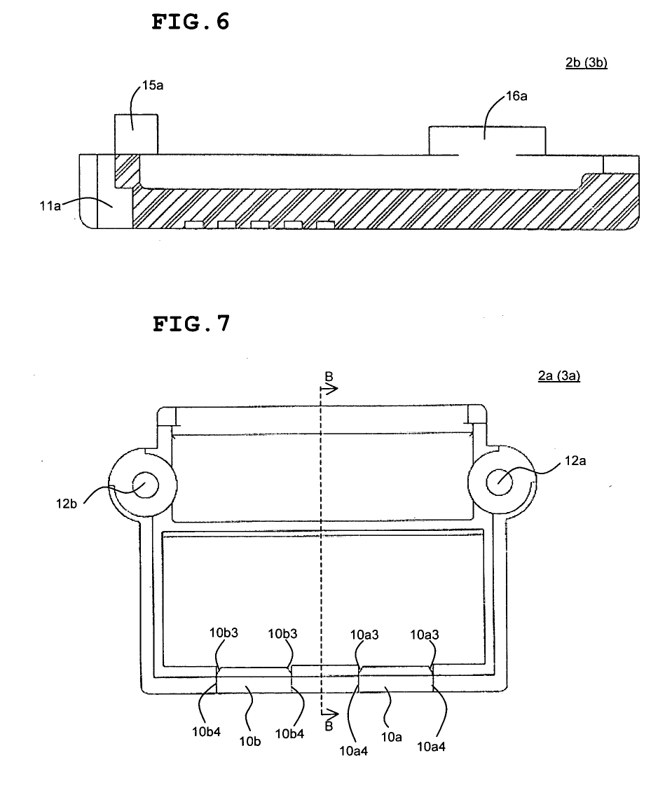

FIGS. 5 and 6 illustrates the bottom housing portion 2b or 3b of either the first housing 2 or the second housing 3, respectively. The bottom housing portion 2b or 3b preferably includes substantially cylindrical portions 16a and 16b which define holes 13a and 13b, respectively. The bottom housing portion 2b or 3b also includes posts 15a and 15b. The printed circuit board 7 is held in place during and after the construction and assembly of the first housing 2 or the second housing 3 by the cylinder portions 16a and 16b and posts 15a and 15b.

The engaging recesses 11a and 11b are preferably substantially rectangular insets as shown in FIG. 6. However, other possible shapes other than substantially rectangular could be used for engaging insets defining the recesses 11a, 11b.

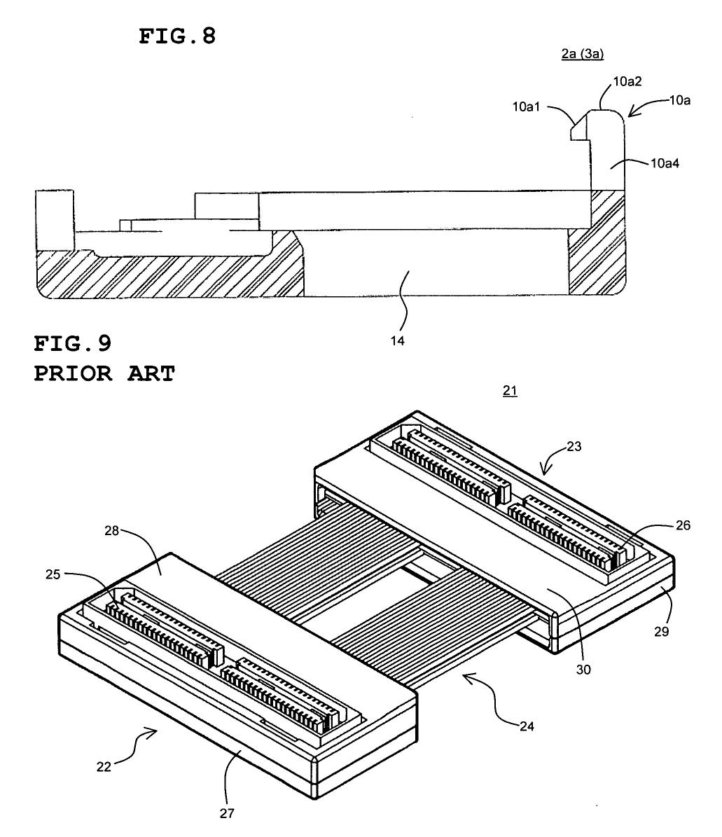

FIGS. 7 and 8 illustrate the top housing portion 2a or 3a of the first housing 2 or the second housing 3, respectively. The top housing portion 2a includes the latch 10a which has a first beveled edge 10a1 along the top surface 10a2 of the latch 10a and a second beveled edge 10a3 along the side surfaces 10a4 of the latch 10a. The latch 10b has a similar structure including a first beveled edge 10b1 along the top surface 10b2 of the latch 10b and a second beveled edge 10b3 along the side surfaces 10b4 of the latch 10b.

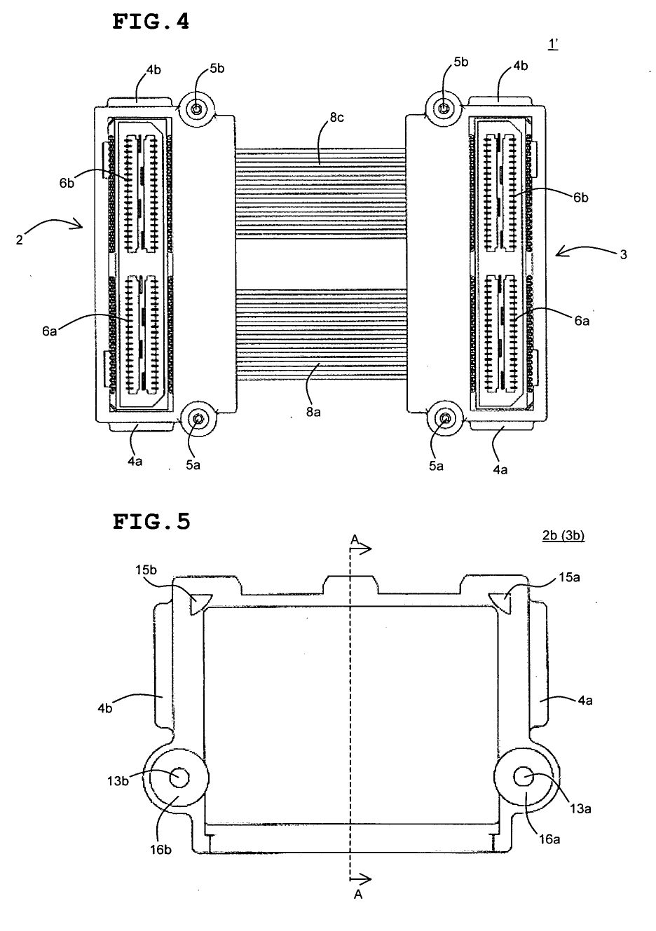

FIGS. 3 and 4 illustrate another preferred embodiment of the present invention. FIGS. 3 and 4 illustrate a high speed cable assembly 1′ which preferably includes a first coaxial cable 8a, a second coaxial cable 8b, a third coaxial cable 8c, and a fourth coaxial cable 8d. The first coaxial cable 8a and second coaxial cable 8b connect first electrical connector portions 6a between the first housing 2 and second housing 3. The third coaxial cable 8c and fourth coaxial cable 8d connect second electrical connector portions 6b between the first housing 2 and second housing 3.

Other possible arrangements than the one shown in FIGS. 3 and 4 could also be used. For example, more than two electrical connectors could be used with more than two pairs of coaxial cables. Also, more than one housing could be used at either or both ends of the cable assembly. For example, one end of the cable assembly could have multiple housings, each enclosing one or more electrical connectors, and the other end of the cable assembly could have one housing enclosing multiple electrical connectors.

As can be clearly understood from the detailed description of preferred embodiments of the present invention above, the cable assembly of preferred embodiments of the present invention achieves many significant advantages not previously attained by conventional devices and solves many problems not recognized or solved by conventional devices. Preferred embodiments of the present invention provide reliably gripping mechanism that allows a cable assembly to be quickly, easily and reliably removed from a PCB upon which it is mounted without any damage to the PCB or the cable assembly or connectors included therein. Thus, the cable assembly of preferred embodiments of the present invention prevents damage caused by the camming effect, prevents unwanted separation of a housing enclosing an electrical connector, and allows for reworking or repair of the coaxial cable without damaging the housing enclosing the electrical connector, while minimizing the assembly steps and the area occupied on a PCB upon which the housing is mounted.

While preferred embodiments of the invention have been described above, it is to be understood that variations and modifications will be apparent to those skilled in the art without departing the scope and spirit of the invention. The scope of the invention, therefore, is to be determined solely by the following claims.

1. A cable assembly for connecting to at least one circuit board, comprising:
first and second housings; and
at least one cable connecting the first and second housings; wherein
at least one of the first and second housings has at least one finger grip provided thereon, the at least one finger grip extending from a surface of the at least one of the first and second housings to allow for finger gripping of the at least one of the first and second housings when the cable assembly is being mounted or has been mounted on the at least one circuit board.

2. A cable assembly according to claim 1, wherein the at least one cable includes a plurality of cables.

3. A cable assembly according to claim 1, wherein the at least one cable is a coaxial cable.

4. A cable assembly according to claim 2, wherein the plurality of cables are coaxial cables.

5. A cable assembly according to claim 1, wherein the at least one finger grip includes two finger grips provided on the at least one of the first and second housings.

6. A cable assembly according to claim 5, wherein the two finger grips are disposed on opposing sides of the at least one of the first and second housings.

7. A cable assembly according to claim 1, wherein the at least one finger grip is a protrusion extending from the surface of the at least one of the first and second housings and arranged to be spaced from an upper surface and a lower surface of the at least one of the first and second housings.

8. A cable assembly according to claim 1, further comprising:
a board; and
at least one electrical connector disposed on the board; wherein
the board connects the at least one cable and the at least one electrical connector, and
the board and the at least one electrical connector are disposed inside of one of the first and the second housings.

9. A cable assembly according to claim 8, wherein the board includes a printed circuit board.

10. A cable assembly according to claim 1, wherein at least one of the housings includes:
a first housing portion; and
a second housing portion; wherein
the first and the second housing portions are removably connected.

11. A cable assembly according to claim 10, wherein the first and second housing portions are removably connected by at least one fastening member.

12. A cable assembly according to claim 10, wherein the first housing portion includes a latch.

13. A cable assembly according to claim 12, wherein the second housing portion includes an engaging recess which is arranged such the latch is a zero insertion force latch mated with the engaging recess.

14. A cable assembly according to claim 12, wherein the latch includes at least one beveled surface.

15. A cable assembly according to claim 8, wherein the at least one electrical connector is a board-to-board connector.

16. A cable assembly according to claim 8, wherein the at least one cable includes a first set of coaxial cables and a second set of coaxial cables.

17. A cable assembly according to claim 16, wherein the first set of coaxial cables is attached to one side of the board by a connection pad; and
the second set of coaxial cables is attached to another side of the board by another connection pad.

18. A cable assembly according to claim 8, further comprising:
a first housing portion; and
a second housing portion; wherein
the board is held in place by at least one cylinder portion and by at least one post located which are located on at least one of the first and second housing portions.

19. A cable assembly according to claim 1, wherein the at least one finger grip is integral with the at least one of the first and second housings.

20. A cable assembly according to claim 1, wherein the at least one finger grip includes a top surface and a bottom surface adapted to be contacted and held by fingers of an operator.
